(19) United States
(12) Patent Application Publication
(10) Pub. No.: US 2009/0032672 A1
(43) Pub. Date: Feb. 5, 2009

(54) Suspension system for product mounted racing computer

(76) Inventors: Stephen Vance Cooper, Amity, OR (US); Jonathan Neal Andrews, McMinnville, OR (US); Weston John Myler, Albany, OR (US); Daniel C. Canfield, McMinnville, OR (US); Richard A. Kirby, Heber City, UT (US)

Correspondence Address: CLARK & BRODY, 1090 VERMONT AVENUE, NW, SUITE 250, WASHINGTON, DC, 20005, US

(21) Appl. No.: 12/071,012

(22) Filed: Feb. 14, 2008

Related U.S. Application Data
(60) Provisional application No. 60/901,107, filed on Feb. 14, 2007.

(51) Int. Cl. F16M 13/02; G01D 21/00; F16M 13/00

(52) U.S. Cl. 248/544; 73/866.5; 248/562

(57) ABSTRACT

A suspension system for a measuring instrument maintains contact with an object to be imaged or measured under circumstances that include a high degree of vibration by providing damping in only one direction. The system includes a rotating shaft with a friction damper that engages the outer surface of the shaft, but relative rotation with respect to the shaft occurs only for rotational motion in one direction.

### CROSS REFERENCE TO RELATED APPLICATION

This application claims priority of U.S. Provisional Application Ser. No. 60/901,107, which was filed on Feb. 14, 2007.

### TECHNICAL FIELD

This invention relates to the art of suspension systems for instruments. In particular the invention relates to a suspension system for an optical instrument module used on a ski.

### BACKGROUND OF THE INVENTION

Performance measurement is an essential element for improvement in every type of sporting event. The old adage applies; “What can be measured can be improved.” Optical navigation technology (most widely known for its application in computer mouse optical motion detection) is uniquely suited for capturing displacement, speed and acceleration information relative the surface being traversed. When applied to the science of sports, it can provide athletes with a powerful tool, creating a digital map as a reference frame from which they can enhance their performance. Mounting a computer mouse to athletic equipment creates its own specialized set of challenges.

Optical computer mouse technology has been initially applied to the ski racing industry. Keeping the optical device in intimate contact with the snow is essential to accurate measurement and uninterrupted data collection. A suspension system that can withstand the rigors of ski racing with speeds in excess of 70 miles per hour and acceleration forces of up to 11 g's is a critical element of the design.

Early system testing revealed that a simple spring-mass system was inadequate. The optical device, with a weight of 5 ounces literally beat itself to pieces in one two-minute test run on an Olympic-class ski racecourse. Traditional suspensions are comprised of linkages, viscous dampers and spring systems that are too bulky and complex for the needs of the ski-racing computer. In general, existing suspensions use one or more elements to perform each function. There are structural elements to decouple the moving part from the fixed part, a viscous damper usually comprised of several individual parts to absorb and dissipate the energy injected into the system and spring elements to supply the return force required to overcome the effect of the damper elements. The physical volume, weight and cost of traditional dampers do not provide an acceptable suspension for a rugged sports environment.

### SUMMARY OF THE INVENTION

In the preferred embodiments, a suspension system according to the invention is separable from the ski, compact, and provides damping only for motions in the upward direction. This allows the optical device to be maintained in constant contact with the snow and perform in excess of a million cycles.

The suspension system for product mounted racing computers according to the invention is comprised of five basic elements. A shaft, preferably of hardened steel, provides the primary structural element of the suspension and serves as a mount for two rotational devices—a torsion spring and a friction band. The suspension system has one degree of freedom, which is the rotational axis of the shaft. The friction band grips the center portion of the shaft preferably on its periphery. The band is preferably made of heat-treated, spring steel with a carefully controlled diameter. The spring properties of the band, in combination with the interference fit with the shaft determine the amount of friction or coulomb damping in the system. Grease is preferably applied to the interface between the shaft and the friction band. The grease eliminates galling between the shaft and the band and in effect, provides a thin film of fluid, which creates some viscous shear when the shaft is rotated relative to the band. The resistive force produced by this combination of elements (shaft, grease and friction band) provides a mixture of coulomb and viscous damping. This system is carefully tuned by techniques known in the art to provide the correct damping force. Other methods of damping could be employed such as grease packed disks, or spring loaded, cork-faced disks.

A torsion spring is used as a second rotational device and has two purposes. First, it provides a relatively constant rotational torque between the fixed and moving parts. In the case of the ski suspension, the fixed part is the “binding,” which is rigidly mounted to the ski. The moving part is the optical device, which is kept in constant contact with the snow. The second function of the torsion spring is to provide a one-way clutch. When the torsion spring is rotated in the direction of its coil windings, the inner diameter of the spring becomes smaller and binds on the shaft. Once there has been sufficient spring rotation for the spring coils to grip the shaft, any further rotation of the spring causes the shaft to rotate relative to the fixed friction band. In this way, the friction band is only active when the shaft rotates, and since the shaft rotates in only one direction, there is only one direction of damping. The direction of shaft rotation is selected to provide damping when the optical device is moving away from the snow. It is free to move unrestrained under the full force of the torsion spring when moving toward the snow. This allows the optical device to maintain constant contact with the snow. The amount of system damping has been selected so that the spring-mass-damper is critically damped. The final element of this structure is a housing that binds some elements to the moving optical device and allows some elements to reference the fixed binding.

Because the optical device is preferably removable from the binding, a sliding plunger or button and a compression spring is positioned on either end of the shaft. When these suspension buttons are pushed from either end, they move in the axial direction against the compression springs. In this way these buttons are “spring loaded” in an outward direction. When snapped into pockets in the binding, the optical device is fixed to the binding with only a rotational degree of freedom. The optical device and suspension can be quickly attached to the binding by pushing the buttons against ramped surfaces built into the binding. These ramped surfaces compress the suspension buttons and allow them to snap into round depressions located in the binding. A second set of binding buttons which are built into the binding provide a means to compress the suspension buttons and release the optical device from the binding.

### BRIEF DESCRIPTION OF THE DRAWINGS

This invention is pointed out with particularity in the appended claims. The above and further advantages of this invention may be better understood by referring to the following description when taken in conjunction with the accompanying drawings, in which:

FIG. 1 is a perspective view of the shaft 101 and friction band 102.

FIG. 2 is a perspective view of the shaft 101, friction band 102, torsion spring 201, torsion spring molded end cap 202 and e-clips 203.

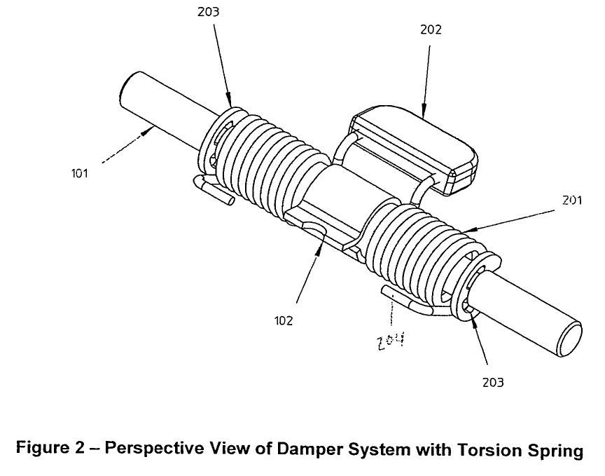

FIG. 3 is a front view of the shaft 101, friction band 102, torsion spring 201, torsion spring molded end cap 202 and e-clips 203, compression springs 301 and suspension buttons 302.

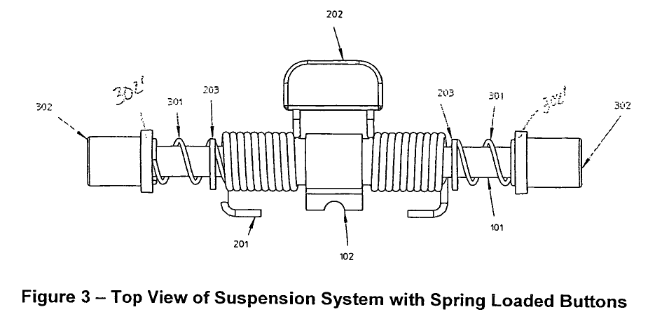

FIG. 4 is a perspective view of the shaft 101, friction band 102, torsion spring 201, torsion spring molded end cap 202 and e-clips 203, compression springs 301 and suspension buttons 302, the suspension lower housing 401 and the binding 402

### DETAILED DESCRIPTION OF THE PREFERRED EMBODIMENT

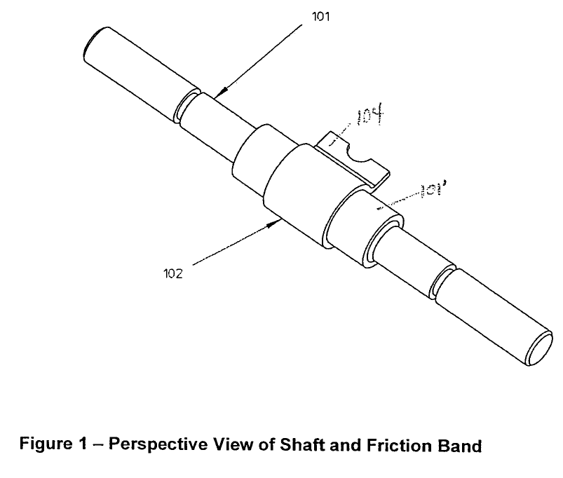

Referring to FIG. 1, the shaft 101 has a larger diameter center section 101′. The diameter of the center section is configured to provide an interference fit with both the friction band and the diameter needed for the spring-clutch to grip the shaft, as will be described below. The length of the large diameter center section 101′ of the shaft is sufficient to capture only a few of the coils of the torsion spring 201. These first few coils provide the clutching action while the remaining coils act only as a torsion spring. In this embodiment, these two functions have been combined into one spring. In alternative embodiments the functions could be separated.

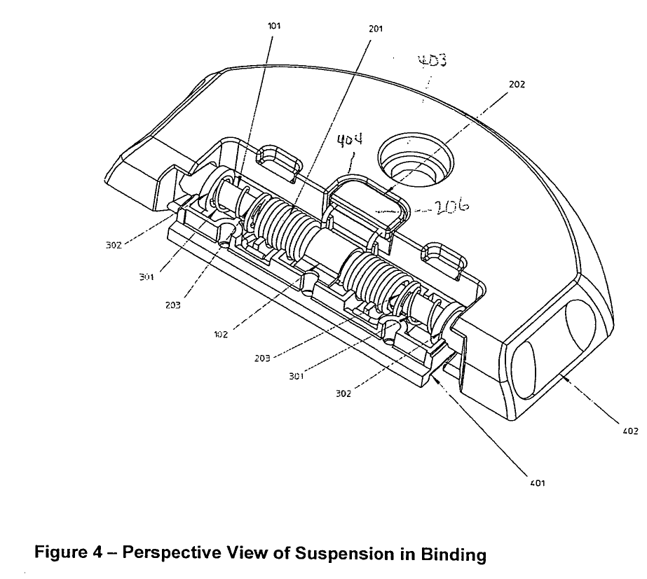

A friction band 102 grips the center section of the shaft 101′ to create a resistive/viscous damping force. The band 102 has a tab 104 on one end, which is secured to the lower housing 401 of the suspension (see FIG. 4). The friction band 102 restrains the rotation of the shaft 101 about its rotational axis. As the lower housing 401 of the suspension rotates clockwise (as viewed from the right end of FIG. 4), the free legs 204 of the torsion spring 201 are forced also to rotate reducing the inner diameter of the torsion spring until the central coils of the spring grip the outer surface of the central portion 101′ of the shaft 101. Further rotation of the lower housing rotates the shaft relative to the friction band 102, creating a resistive/viscous damping force. When the suspension lower housing is rotated in the opposite direction, the clutching action of the torsion spring 201 is released, and the shaft does not rotate relative to the friction band 102, and the suspension lower housing 401 is acted upon by the full rotational force of the torsion spring 201. The fixed end 202 of the torsion spring is restrained in its rotation by the binding 402. The suspension 401 can be removed from the binding because the non-rotating end 202 of the torsion spring is not fixed to the binding. It rests in a pocket 404 on the top of the binding 402. A molded cap 206 allows for smooth engagement with the binding 402 when the suspension system is inserted into the binding.

The two E-clips 203 perform two separate functions. First, they retain the torsion spring 201 in a position that is centered on the shaft 101. Second, they provide a “stop” for compression springs 301. The suspension buttons 302 engage the binding 402 to mount the suspension on the binding. The suspension buttons preferably include flanges 302′ at their inner ends to retain the buttons, which are captured in the suspension lower housing. The suspension buttons are free to slide in and out on the shaft and are spring-loaded outwardly by the compression springs 301. The buttons are preferably made of a self-lubricating plastic providing a bushing between the rotating shaft and the stationary binding.

In use, the binding may be mounted to a ski (not illustrated), as by a screw passing through a mounting hole 403, and an optical measuring instrument that measures the motion of the ski is attached to lower housing 401 of the suspension. Of course other means may be used to attach the binding to the ski, as by an adhesive, and the measuring instrument need not be optical, but could be of various types that require contact with the snow or other surface on which the ski is used.

Modifications within the scope of the appended claims will be apparent to those of skill in the art. For example, while the structure disclosed provides advantages, it is within the scope of the invention to provide a one way damping system that incorporates linear motions instead of the rotational motions described.

1-4. (canceled)

5. A system for mounting and suspending an optical device from an object sliding on a surface of snow or ice comprising:
a linkage device to connect said optical device to said object sliding on a surface of snow and ice
said linkage device comprising at least one rotational axis parallel to the axis of said object sliding on a surface of snow and ice
a bias device to bias said optical device against said surface of snow and ice
a damping device for damping said bias device
and a clutch device to engage said damping device in the upward direction only.

6. The system of claim 5 wherein said damping device comprises a friction damping device.

7. The system of claim 6 wherein said friction damping device comprises a friction band.

8. The system of claim 6 wherein said friction damping device comprises a grease packed disk.

9. The system of claim 6 wherein said friction damping device comprises a cork faced disk.

10. The system of claim 5 further comprising a quick release device for allowing a portion of said system for mounting and suspending a sliding non-contact measurement device to be removed from said object sliding on a surface of snow and ice.

11. The system of claim 5 further comprising a safety device which permits the retracting of said optical device.

12. The system of claim 5 where said bias device is a torsion spring.

13. A system for mounting and suspending an optical device from an object sliding on a surface of snow or ice comprising:
A binding device attached to said object sliding on a surface of snow or ice
a linkage device to connect said binding to said object sliding on a surface of snow and ice
said linkage device comprising at least one rotational axis parallel to the axis of said object sliding on a surface of snow and ice
a bias device to bias said optical device against said surface of snow and ice
a damping device for damping said bias device
and a clutch device to engage said damping device in the upward direction only.

14. The system of claim 13 wherein said damping device is a friction damping device.

15. The system of claim 14 wherein said friction damping device comprises a friction band.

16. The system of claim 14 wherein said friction damping device comprises a grease packed disk.

17. The system of claim 14 wherein said friction damping device comprises a cork faced disk.

18. The system of claim 13 further comprising a quick release device for allowing a portion of said system for mounting and suspending a sliding non-contact measurement device to be removed from said object sliding on a surface of snow and ice.

19. The system of claim 13 further comprising a safety device which permits the retracting of said optical device.

20. The system of claim 13 where said bias device is a torsion spring.
